(19) United States
(12) Patent Application Publication
(10) Pub. No.: US 2002/0092982 A1
(43) Pub. Date: Jul. 18, 2002

(54) High frequency dithering probe for high speed scanning probe microscope

(76) Inventors: Won Ho Jhe, Seoul (KR); Yong Ho Seo, Seoul (KR)

Correspondence Address: OPPENHEIMER WOLFF & DONNELLY, P. O. BOX 10356, PALO ALTO, CA, 94303, US

(21) Appl. No.: 09/858,350

(22) Filed: May 15, 2001

(30) Foreign Application Priority Data
Jan. 15, 2001 (KR) 2188/2001
Apr. 13, 2001 (KR) 19889/2001

(51) Int. Cl. G21K 7/00; G01N 23/00

(52) U.S. Cl. 250/306

(57) ABSTRACT

A high frequency dithering probe for a high speed scanning probe microscope includes a high frequency quartz-crystal resonator having a fundamental resonant frequency in the range of 1 MHz˜100 MHz and a thickness of 0.01 mm˜2.0 mm, an electrode attached to the quartz-crystal resonator, and a probe attached to the quartz-crystal resonator. With the high frequency dithering probe having the improved scanning speed, a test sample can be observed within a short time and an object being changed can be also observed.

### BACKGROUND OF THE INVENTION

1. Field of the Invention

The present invention relates to a dithering probe for a high speed scanning probe microscope, and more particularly, to a high frequency dithering probe attached to a quartz-crystal resonator with a remarkably improved scanning speed.

2. Description of the Background Art

A scanning probe microscope (SPM) is used to measure the topography of a surface and other physical characteristics by moving a probe with a tipped end horizontally and vertically over a surface to be measured.

The scanning probe microscope includes various types such as an STM (scanning tunneling microscope), an atomic force microscope (AFM), a near field scanning optical microscope (NSOM) or a magnetic force microscope (MFM).

The general optical microscope has a limitation (200˜300 nm) in its resolution due to the diffraction phenomenon of light, which is called a diffraction limitation.

However, the scanning probe microscope has a high resolution which is hardly obtained by using the optical microscope.

In case of a contact-mode scanning probe microscope, as the probe touches on a surface, the surface may be damaged. This microscope is complemented by a noncontact mode scanning probe microscope. As for the noncontact mode scanning probe microscope, its probe is dithered with a very small amplitude (smaller than its resolution) and the dithering amplitude is observed to prevent the probe from colliding with a test sample.

When the dithering probe is distanced from the test sample, it has a constant dithering amplitude. But as it approaches the test sample, its amplitude becomes reduced. Since the amplitude is much reduced just before the probe almost touches the test sample, the distance between the probe and the test sample needs to be adequately adjusted before they collide with each other, whereby the noncontact mode scanning probe microscope is implemented.

The probe may be dithered in the vertical direction or in the horizontal direction relative to the test sample. The former is called a tapping mode, while the latter is called a shear force mode.

There are several methods for dithering the probe. For example, the probe can be dithered by attaching two sheets made of a piezoelectric material, or a tuning fork, a kind of crystal resonator, may be used.

Recently, the tuning fork is mostly used thanks to its convenient usage and good sensitivity (refer to K. Karrai et al. Appl. Phys. Lett. 66, 1842 (1995)).

As shown in FIG. 1, the tuning fork 10 may be formed in the shape of two long parallel branches, with a probe 13 made of an optical fiber attached to one branch, which implementation is widely used.

When a voltage of the same frequency as a fundamental resonant frequency of the tuning fork is applied to one electrode 11 of the tuning fork, the two branches of the tuning fork are dithered in opposite directions to each other, and a voltage in proportion to the size of the dithering is induced to the other electrode 12.

Thus, after a probe is attached to one branch of the tuning fork, when a voltage is applied thereto, the probe is accordingly moved, and as the probe approaches the test sample, the amplitude of the probe is reduced due to the shear force and the amplitude of the branch of the tuning fork is accordingly reduced, and thus, the voltage induced to the other electrode is accordingly reduced.

That is, since the amplitude of the induced voltage is in proportion to the dithering amplitude of the probe, the dithering (amplitude) of the probe can be measured. Namely, the tuning fork informs of the variation of the amplitude of the probe as well as dithering the probe.

The noncontact scanning probe microscope measures the distance between the probe and the test sample by dithering the probe in the horizontal direction relative to the test sample and measuring the amplitude of the dithering or the variation in phase by using the tuning fork.

In spite of the advantages that the test sample can be observed without doing damage to the test sample, the noncontact mode scanning probe microscope has a problem that since it takes too long (several minutes) to obtain an image, it is impossible to observe an object which is changed in a very short time. The reason for this is that the scanning speed is slow due to the tuning fork which has a low resonant frequency.

The tuning fork is a sort of crystal resonator of which the fundamental resonant frequency remains at about tens of kHz. Thus, as the resonant frequency of probe attached to the tuning fork is just tens of kHz, the reaction speed is slow, resulting in that the scanning speed is degraded, which slows the time required to obtain a final image.

### SUMMARY OF THE INVENTION

Therefore, an object of the present invention is to provide a high frequency dithering probe for a high speed scanning probe microscope which is capable of observing a test sample within a short time by improving a scanning speed of a dithering probe and which is thereby capable of observing an object being changed.

Another object of the present invention is to provide a high frequency dithering probe suitable for a general noncontact mode scanning probe microscope or a near field scanning optical microscope (NSOM).

To achieve these and other advantages and in accordance with the purpose of the present invention, as embodied and broadly described herein, there is provided a high frequency dithering probe for a high speed scanning probe microscope including a quartz-crystal resonator which has a fundamental resonant frequency of 1 MHz˜100 MHz and a thickness of 0.01 mm˜2.0 mm, an electrode attached to the quartz-crystal resonator and a probe attached to the quartz-crystal resonator.

The quartz-crystal resonator may take various forms. Preferably, in order to have a high frequency, it has a flat disk form with a thickness of 0.01 mm˜2.0 mm and a cross-sectional area of tens of mm². The disk type of quartz-crystal resonator has advantages in that it is easily fabricated and a cantilever or a needle type of probe can be easily attached thereto.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a tuning fork crystal resonator for a scanning probe microscope in accordance with a conventional art

FIG. 2A is a plan view of a high frequency quartz-crystal resonator in accordance with the present invention;

FIG. 2B is a side view of the high frequency quartz-crystal resonator of FIG. 2A in accordance with the present invention;

FIG. 2C is a side view of a first example of a high frequency quartz-crystal resonator with a probe attached on the surface of the central portion thereof in accordance with the present invention;

FIG. 2D is a side view of a second example of a high frequency quartz-crystal resonator to which an optical fiber is mounted in accordance with the present invention;

FIG. 2E is a side view of a third example of a high frequency quartz-crystal resonator with a probe attached at an end portion thereof in accordance with the present invention;

FIG. 2F is a side view of a fourth example of a high frequency quartz-crystal resonator with a cantilever attached on the surface thereof in accordance with the present invention;

FIG. 2G is a side view of a fifth example of a high frequency quartz-crystal resonator with a cantilever attached at the end thereof in accordance with the present invention;

FIG. 3A is a schematic view showing the construction of a near field scanning optical microscope using the quartz-crystal resonator of FIG. 2C in accordance with the present invention;

FIG. 3B is a schematic view showing the construction of a near field scanning optical microscope using the quartz-crystal resonator of FIG. 2D in accordance with the present invention;

FIG. 4 is a schematic view showing the construction of a scanning probe microscope using a high frequency quartz-crystal resonator in accordance with the present invention;

FIG. 5 is a graph showing the variation in amplitude as a dithering probe of the high frequency quartz-crystal resonator approaches the surface of a test sample in accordance with the present invention;

FIGS. 6A and 6B are microphotographs of a CD (Compact Disc) surface observed by means of an atomic force microscope in accordance with the present invention, of which

FIG. 6A shows the topography of the CD surface; and

FIG. 6B shows the variation of an error signal; and

FIGS. 7A and 7B are microphotographs of a grating surface taken by the near field scanning optical microscope in accordance with the present invention, of which

FIG. 7A is a microphotograph taken for 0.4 seconds of an area of 7.4×7.4 μm²; and

FIG. 7B is a microphotograph taken for 2 seconds of an area of 1.8×1.8 μm²; and

FIG. 8 is a microphotograph of the surface of a CD taken by an atomic force microscope using the quartz-crystal resonator of FIG. 2E in accordance with the present invention.

### DETAILED DESCRIPTION OF THE PREFERRED EMBODIMENTS

Reference will now be made in detail to the preferred embodiments of the present invention, examples of which are illustrated in the accompanying drawings.

The high frequency dithering probe is used for a scanning probe microscope, and especially can be used for a near field scanning optical microscope (NSOM) or a noncontact atomic force microscope. The high frequency quartz-crystal resonator has a resonant frequency of a few MHz to hundreds of MHz. Thus, compared to the conventional tuning fork, its response time becomes faster by more than 100 times, and thus, the time required for obtaining an image can be reduced to 1/100.

When a probe attached at the dithering quartz-crystal resonator approaches near a test sample or becomes distanced, therefrom if the amplitude of the probe decreases or increases as it is instantly reacted on the distance with respect to the test sample, that is, the response time of the quartz-crystal resonator is fast, the time taken for controlling the distance between the test sample and the probe would be shortened and thus, the scanning speed becomes fast. That is, the response time of the quartz-crystal resonator determines the scanning speed.

Theoretically, the response time of the resonator is given by τ=√3Q/πf₀, wherein ‘Q’ indicates the quality factor of the resonator and f₀ indicates the fundamental resonant frequency. Accordingly, the response time can be made faster by lowering ‘Q’ or raising ‘f₀’. Accordingly, in case that the probe is attached to a resonator which is capable of dithering the probe at even higher frequency for use, the resonant frequency of the probe can be heightened and its response time can be fast.

As for the scanning probe microscope, the response time of an electric feedback circuit should be also improved as well as making the response time of the dithering probe fast. Besides, the response time of a PZT position control apparatus needs to be fast.

The response time of the feedback circuit is mostly determined by the time constant of a lock-in amplifier, because a long time constant is used to reduce the noise of an output result of the lock-in detector.

The dithering amplitude of the tuning fork is in proportion to the amplitude of a voltage. In order to obtain a high resolution image, the dithering amplitude should be small. In this respect, generally, the amplitude of a voltage needs to be lowered down to about a few mV to be used.

Since the small signal magnitude is buried in the neighboring electric noise, a component of a corresponding frequency is extracted by using a lock-in detection and a DC output in proportion to the amplitude is obtained to be fed back. In this process, in order to raise the signal-to-noise ratio of the DC output, a long time constant is given and an averaged signal is used.

Such composite processes result from the great dithering amplitude of the tuning fork. If the dithering amplitude becomes great, the signal-to-noise ratio is reduced, so that a fast feedback can be done with a short time constant, but the resolution is degraded. Conversely, if the dithering amplitude is reduced to obtain a higher resolution, the time constant is lengthened, resulting in that the scanning time is lengthened.

A solution to the problem of the conventional art is the development or selection of a dithering material having a small dynamic dithering and great amplitude of an electric voltage. If such material is selected, since its electrical signal is great, its noise is relatively small, so that a lock-in amplifier is not required to be used. Then, the structure of the whole system is simplified and its production cost can be much reduced.

In the present invention, as a dithering material satisfying the above-described conditions, a high frequency quartz-crystal resonator is used.

The high frequency quartz-crystal resonator has a high fundamental resonant frequency f₀, a small dynamic dithering and a great amplitude of electrical voltage, so that it can solve the problem of the conventional art.

In order to apply the high frequency quartz-crystal resonator to a scanning probe microscope, it is important to connect a probe to the quartz-crystal resonator and dither the probe.

The high frequency quartz-crystal resonator is susceptible to the ambient environment. For example, the resonant frequency and the amplitude is much changed depending on the temperature, the humidity and the pressure.

In addition, when an object is attached to or contacts the high frequency quartz-crystal resonator, the oscillation is damped or even.

Accordingly, when the quartz-crystal resonator is dithered, the probe should be also dithered and the force affecting the probe (i.e., a shear force) when the probe approaches the test sample should be transmitted to the quartz-crystal resonator.

In order to satisfy those conditions, in the present invention, the mass of the probe is reduced and the probe is tightly attached to the high frequency quartz-crystal resonator, so that the two objects are moved together. Preferably, the probe has a length of less than 2 mm in consideration of obtaining a smaller mass and attachment to the quartz-crystal resonator.

The present invention will now be described in detail with reference to the accompanying drawings.

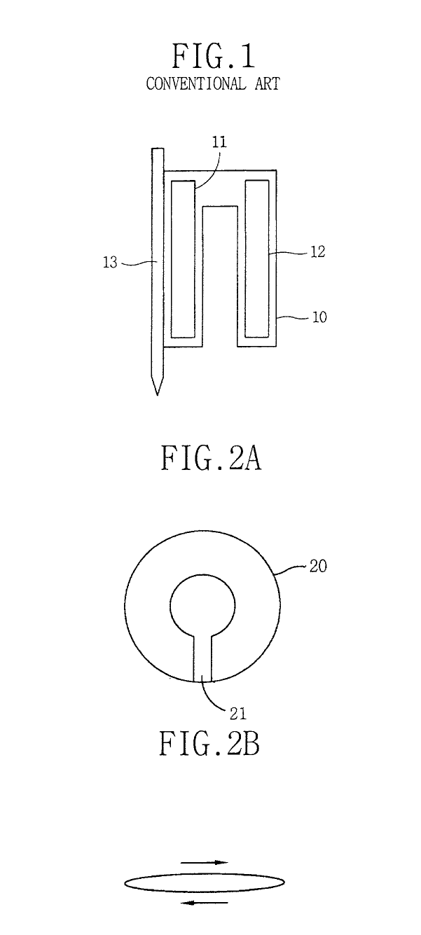

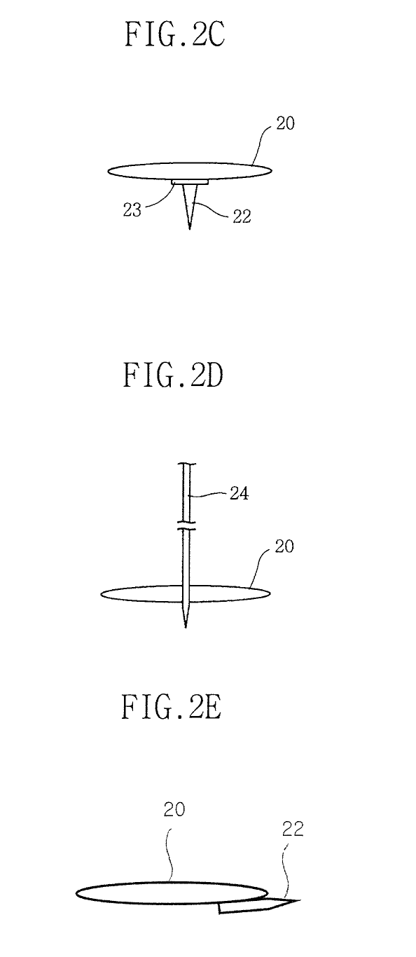

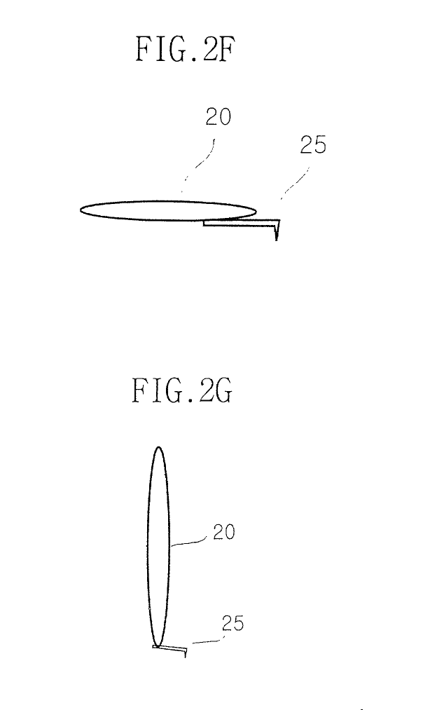

FIG. 2A is a plan view of a high frequency quartz-crystal resonator.

As shown in the drawing, a quartz-crystal is cut in the AT-cut direction to make a plate form. An electrode 21 is attached at both the front and the rear surface to form a high frequency quartz-crystal resonator 20. In the preferred embodiment of the present invention, a key hole-shaped electrode is coated on both surfaces of the quartz-crystal (the rear surface is not shown), from which a voltage induced according to the dynamic dithering may be measured, or a dynamic dithering may be induced to the quartz-crystal by applying a voltage to the electrode.

In case of the AT-cut quartz-crystal resonator, the frequency is not much changed depending on the temperature at room temperature. Thus, it is suitable for the atomic force microscope in use at a room temperature.

The fundamental resonant frequency is determined depending on the thickness of the quartz-crystal resonator. In the preferred embodiment, the fundamental resonant frequency of the high frequency quartz-crystal resonator is 2 MHz, which corresponds to about 0.85 mm in thickness.

FIG. 2B is a side view of the high frequency quartz-crystal resonator of FIG. 2A in accordance with the present invention, showing a resonance direction.

As shown in the drawing, when a dynamic impact is applied to the quartz-crystal resonator, the upper and the lower surfaces are horizontally dithered in the opposite directions according to the fundamental resonant frequency.

In the preferred embodiment of the present invention, when the quartz-crystal resonator is dithered, the amplitude of the-resonance is the greatest at its central portion. Thus, in order to obtain the greatest sensitivity, the probe should be positioned at the center of the quartz-crystal resonator.

FIG. 2C is a side view of an example of a high frequency quartz-crystal resonator with a probe attached in accordance with the present invention.

In order to have the great sensitivity, a probe 22 is attached to extend from the center of the quartz-crystal resonator 20. In this case, the adhesive force between the quartz-crystal and the probe is a critical variable. In the present invention, the quartz-crystal resonator and the probe are firmly adhered by using an instantaneous adhesive. Reference numeral 23 denotes the attachment portion

After heating an optical fiber by a laser, when the both ends of the optical fiber are stretched, the middle portion becomes very thin like a needle. In the preferred embodiment, an optical fiber tip in such a needle form is used as the probe. The needle-shaped probe is also used as a probe for the near field scanning optical microscope. Accordingly, the quartz-crystal resonator of the present invention can be applied to the near field scanning optical microscope.

In addition, as a probe in the present invention, a tungsten tip or a carbon nanotube can be used.

FIG. 2D is a side view of another example of a high frequency quartz-crystal resonator in which a through-hole is made at the center and a needle-shaped optical fiber 24 is inserted therethrough to thereby integrate the quartz-crystal resonator and the optical fiber in accordance with the present invention.

In detail, the optical fiber-integrated quartz-crystal resonator is fabricated in a manner that the tip of a long optical fiber is sharpened to form a probe and the probe is inserted into the hole in the quartz-crystal resonator as it is without being cut off.

In this respect, if the hole is too large, the quartz-crystal resonator may lose a fundamental resonance mode or the ‘Q’ value may be much reduced. Accordingly, the hole size needs to be a bit greater than the diameter of a cladding as a jacket of the optical fiber is taken off.

In the preferred embodiment of the present invention, the cladding of the optical fiber used has a diameter of 125 μm and the hole in the quartz-crystal resonator has a diameter of 150 μm. There is thus a gap between the hole and the optical fiber. An adhesive is injected to fill the gap, and once so adhered then as the quartz-crystal resonator is dithered, the probe is also dithered. FIG.

FIG. 2E is a side view of a third example of a high frequency quartz-crystal resonator with a probe attached at an end portion thereof in accordance with the present invention.

In this case, it is easy to attach the probe to the quartz-crystal resonator and a high ‘Q’ value can be obtained. In addition, the direction of dithering of the quartz-resonator may be parallel to the longitudinal direction of the probe or at a right angle to the probe. If the direction of dithering is made parallel to the probe, it becomes suitable for a tapping mode atomic force microscope.

FIG. 2F is a side view of a fourth example of a high frequency quartz-crystal resonator with a cantilevered probe (hereinafter “cantilever”) attached on the surface thereof in accordance with the present invention.

As shown in FIG. 2F, a cantilevered probe is attached on one surface of the quartz-crystal resonator 20. The cantilever is attached to the quartz-crystal resonator by using an adhesive. Or, a Si wafer is attached on one surface of the quartz-crystal resonator, and is then etched into the cantilever form. In this respect, the length, the weight and the elastic coefficient of the cantilever may be varied to have different dithering characteristics.

For example, the resonant frequency of the quartz-crystal resonator may be the same as that of the cantilever or made to be an integer multiple, or a dithering probe may be made to have a high Q value.

In addition, in the case where the resonant frequency of the quartz-crystal resonator and the resonant frequency of the cantilever are much different, both dithering phenomena may be simultaneously measured to obtain different information.

FIG. 2G is a side view of a fifth example of a high frequency quartz-crystal resonator with a cantilever attached at the end thereof in accordance with the present invention.

As shown in FIG. 2G, a cantilever may be fabricated separately, to be attached to the quartz-crystal resonator. Or, as in the case with reference to FIG. 2F, the cantilever can be integrally fabricated with the quartz-crystal resonator.

At this time, preferably, the tip of the quartz-crystal resonator is a bit cut out and a cantilever is attached thereto to firmly attach the cantilever to the quartz-crystal resonator, to obtain a high sensitive atomic force microscope.

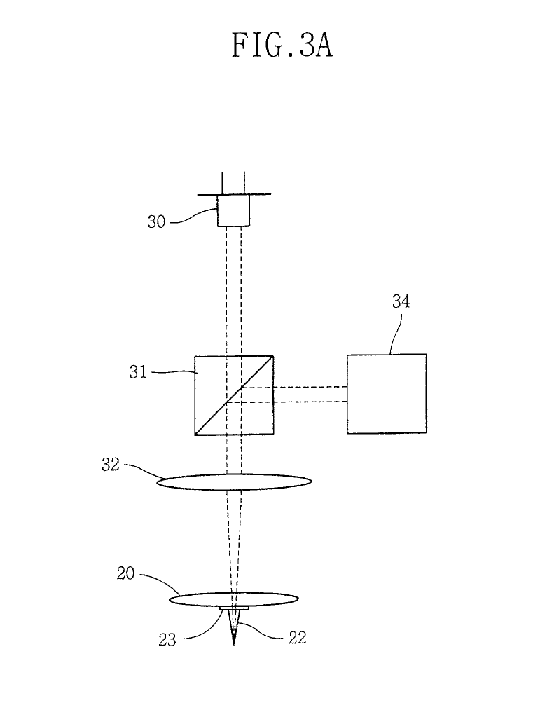

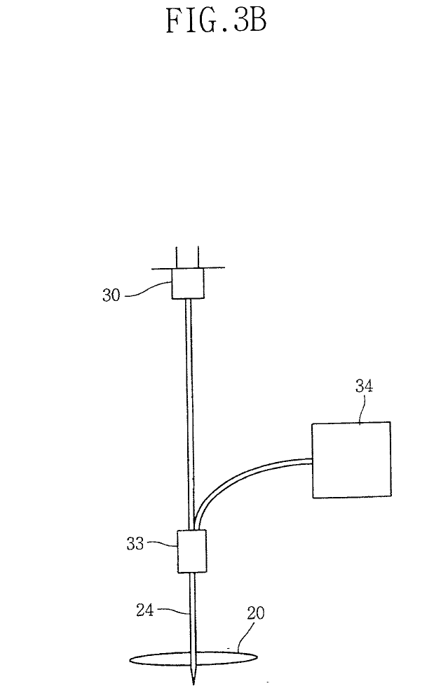

FIGS. 3A and 3B show examples of application of the high frequency quartz-crystal resonator to the near field scanning optical microscope.

FIG. 3A illustrates the near field scanning optical microscope using the quartz-crystal resonator of FIG. 2C.

As shown in the drawing, a transparent probe 22 is attached to project from the high frequency quartz-crystal resonator 20 by using an adhesive 23, and light generated from an optical source 30 is focused on the tip of the probe 22 after passing through a beam splitter 31 and an objective lens 32. The light reflected from the probe is transmitted from the beam splitter 31 to a light sensor 34.

The quartz-crystal resonator 20 is made of a transparent material, through which light is well transmitted. But in the case of a translucent electrode (not shown) coated on the front and the rear surfaces of the quartz-crystal resonator, it has a bad transmissivity, which, thus, needs to be modified.

For example, first, a part of the central portion of the electrode is removed and polished, so that the light can be well transmitted therethrough. Certainly, this does not ruin the function of the electrode. As another solution, a transparent electrode ( i.e. Indium Tin Oxide, etc.) may be used.

FIG. 3B illustrates a near field scanning optical microscope using the quartz-crystal resonator probe of FIG. 2D.

In this embodiment, a part of a central portion of an electrode (not shown) coated on the quartz-crystal resonator 20 is removed, and a hole is made through the center of the quartz-crystal resonator, into which an optical fiber 24 is inserted and light is made incident to and transmitted through the optical fiber. Since the light is directly made incident on the optical fiber from the optical source 30, an objective lens is not necessary. The reflected light from the probe tip is transmitted through a coupler 33 to the light sensor 34.

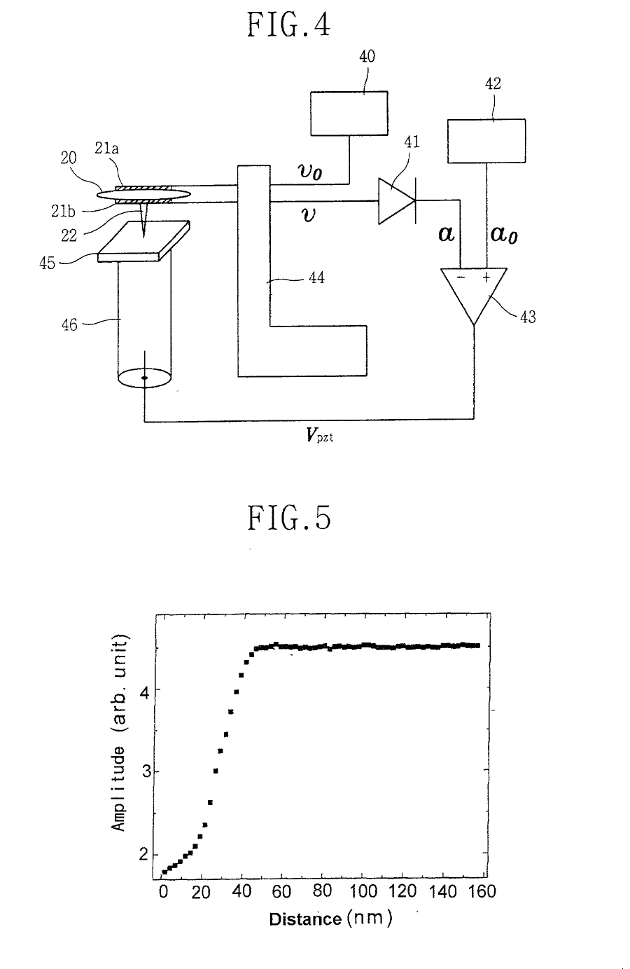

FIG. 4 is a schematic view showing the construction of a scanning probe microscope using a high frequency quartz-crystal resonator in accordance with the present invention.

As shown in the drawing, when a frequency synthesizer 40 applies an AC voltage v₀ corresponding to the fundamental resonant frequency of the quartz-crystal resonator to one electrode 21a of the quartz-crystal resonator 20 mounted to a position control stage 44, the quartz-crystal resonator is dithered, according to which the probe 22 attached to the quartz-crystal resonator is dithered.

As the dithering is changed as the probe moves over the surface of a test sample 45, an induced voltage ‘ν’ is generated at the other electrode 21b according to the amount of change. The voltage ‘ν’ is applied to a diode 41, whereby a DC signal ‘a’ in proportion to the amplitude of the voltage is obtained, and a voltage integrated in proportion to the difference between the amplitude of DC signal ‘a’ and a reference voltage a₀ from a reference voltage generator 42 is amplified (V_{pzt}) at a high gain (this is called a PI or proportional integrating controlling method) and applied to a PZT position controller 46, thereby completing a feedback loop. The atomic force microscope using the high frequency quartz-crystal resonator does not need a lock-in amplifier. Thus, its apparatus has a simple construction, and its fabrication cost is very low.

FIG. 5 is a graph showing that as the probe attached at the high frequency quartz-crystal resonator approaches the test sample, the amplitude of the induced voltage according to the resonance of the probe is reduced.

As shown in the graph, when the probe is distanced from the test sample, the amplitude is constantly maintained. However, as the probe nears to the 40 nm distance from the sample, the amplitude is suddenly reduced. In this respect, it is noted that the voltage is much reduced in the range of about 30 nm, so a requirement as a distance control sensor can be sufficiently satisfied. Accordingly, after the distance between the test sample and the probe is measured on the basis of the amplitude of the induced voltage, the distance between the probe and the test sample can be uniformly controlled by using the feedback circuit of FIG. 4.

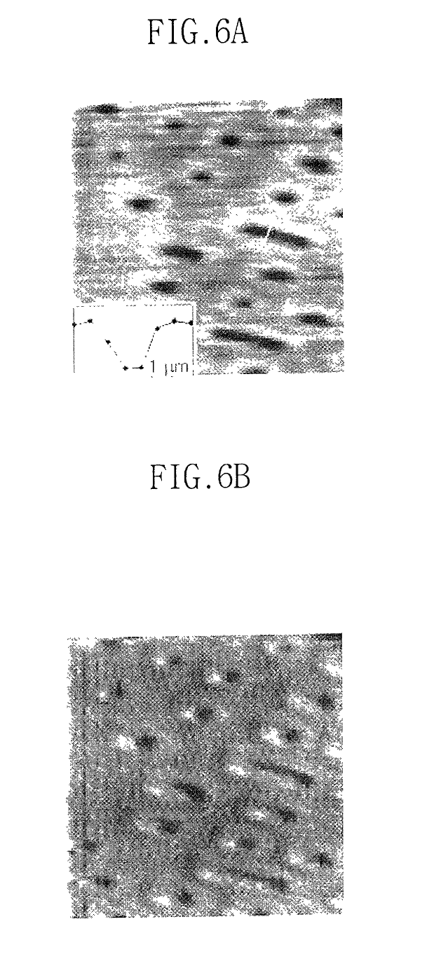

FIGS. 6A and 6B show results of an observation of the surface of the test sample by using a noncontact AFM which adopts the quartz-crystal resonator (refer to FIG. 2C) with the probe attached, of which FIG. 6A shows the topography of a CD (Compact Disk) surface, and FIG. 6B shows the variation of an error signal.

As a test sample, a CD was used, the scanned area was 55 μm², and the total moved distance was 0.5 mm. Time taken for obtaining the image was just 0.4 seconds, during which the scanning speed was 1.2 mm/s.

That is, compared to the case of using the conventional tuning fork type probe, the scanning speed was improved by about 10 times to 100 times.

The smaller view in FIG. 6A is a graph showing a section of the line shown in the white color, in which block points are measured in 10 nm intervals which is considered to be as good as the resolution of the conventional noncontact AFM.

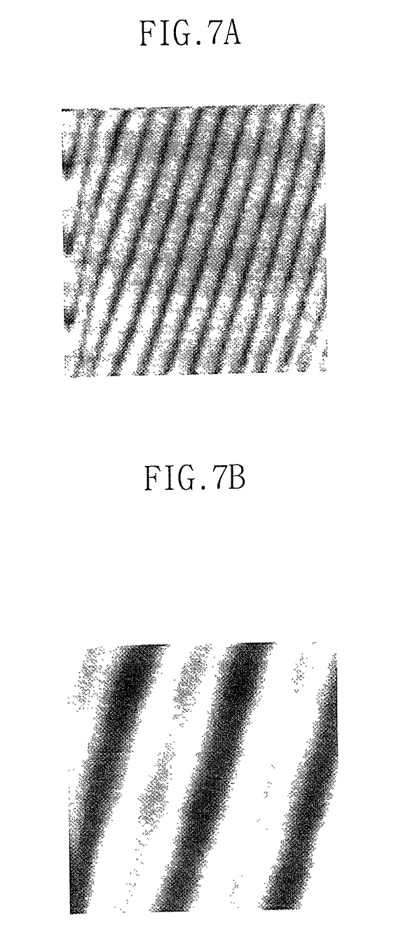

FIGS. 7A and 7B are microphotographs of a grating surface taken by a near field scanning optical microscope using the quartz-crystal resonator of FIG. 2D fabricated by making a hole in the resonator and inserting the optical fiber thereinto in accordance with the present invention, of which FIG. 7A is a microphotograph taken for 0.4 seconds over an area of 7.4×7.4 μm² , and FIG. 7B is a photograph taken for 2 seconds over an area of 1.8×1.8 μm².

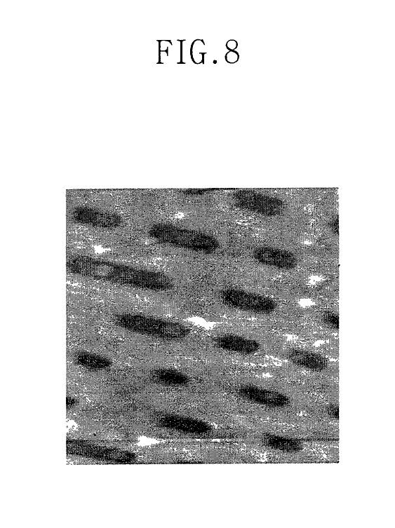

FIG. 8 is a microphotograph of the surface of the CD taken by the atomic force microscope using the quartz-crystal resonator with a probe made of an optical fiber attached at the tip thereof of FIG. 2E in accordance with the present invention.

The area of 8×8 μm² was photographed for 30 seconds. Compared with the result of FIG. 6A, though the scanning time is prolonged, it is noted that the resolution was considerably improved.

The results of FIGS. 6A through 8 show that no matter where the probe is attached in the quartz-crystal resonator, it can be used with the atomic force microscope. In addition, the quartz-crystal-resonator is operable in various modes such as a shear force mode or a tapping mode according to the attached position of the probe.

As so far described, in the case of the general optical microscope, though it allows an observer to directly observe the change of the test sample on a real time basis, its resolution is not so good. In the case of the near field scanning optical microscope, its resolution is excellent but its speed is so slow that it is impossible to observe the test sample being changed on a real time basis.

However, in case of the high frequency dithering probe for a high speed scanning probe microscope, the test sample while being changed can be observed on a real time basis, so that it is adoptable to the fields of applied science such as semiconductor or information communication as well as the fields of pure science such as physics, chemistry or biology.

Especially, with respect to the fields of medical science and life science, up to now, there have been no tools available to research directly a virus having a size of from dozens of nm to hundreds of nm, because the virus is too small to observe with an optical microscope and it is not possible to photograph a moving virus by using the AFM having the conventional slow scanning speed or the near field optical microscope.

However, the present invention is expected to be adopted in diverse fields such as for observing growth of bacteria, variation of DNA or cell division.

Recently, development and operation of nanomaterials moves into the limelight, however, since no microscope has been developed to photograph the change of a nano-size material, this has hindered further research and development.

Thus, the high frequency dithering probe for a high speed scanning probe microscope of the present invention is expected to be a good tool for photographing the dynamic variation of nano particles and the fabricating process of a nano material (i.e., a thin film fabrication, a nano tube growth, a nano lithography, etc.)

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A high frequency dithering probe for a high speed scanning probe microscope, comprising:
a high frequency quartz-crystal resonator having a fundamental resonant frequency in the range of 1 MHz˜100 MHz and a thickness of 0.01 mm˜2.0 mm;
an electrode attached to the quartz-crystal resonator; and
a probe attached to the quartz-crystal resonator.

2. The high frequency dithering probe of claim 1, wherein the quartz-crystal resonator is formed in a flat disk type shape with a thickness of scores of mm².

3. The high frequency dithering probe of claim 1, wherein the probe is attached on the surface of the quartz-crystal resonator.

4. The high frequency dithering probe of claim 3, wherein the probe is a cantilever attached to the quartz-crystal resonator.

5. The high frequency dithering probe of claim 3, wherein the probe is a sharpened optical fiber tip.

6 The high frequency dithering probe of claim 3, wherein the probe is a tungsten tip.

7. The high frequency dithering probe of claim 3, wherein the probe is a carbon nanotube.

8. The high frequency dithering probe of claim 3, wherein the scanning probe microscope is a noncontact mode atomic force microscope (AFM).

9. The high frequency dithering probe of claim 3, wherein the probe is made of a transparent material to transmit light therethrough.

10. The high frequency dithering probe of claim 1, wherein the probe is attached to the quartz-crystal resonator in such a manner that it extends through a hole formed in the high frequency quartz-crystal resonator.

11. The high frequency dithering probe of claim 10, wherein the probe is an optical fiber tip.

12. The high frequency dithering probe of claim 10, wherein the scanning probe microscope is a noncontact mode atomic force microscope (AFM).

13. The dithering probe of claim 10, wherein the scanning probe microscope is a near field scanning optical microscope (NSOM).

14. The high frequency dithering probe of claim 10, wherein the probe is made of a transparent material to transmit light therethrough.

15. The high frequency dithering probe of claim 14, wherein the electrode is removed at the portion of the quartz-crystal resonator where the probe is attached to.

16. The high frequency dithering probe of claim 14, wherein the electrode is transparent.

17. The dithering probe of claim 14, wherein the scanning probe microscope is a near field scanning optical microscope (NSOM).
